(19) United States
(12) Patent Application Publication
(10) Pub. No.: US 2026/0245313 A1
(43) Pub. Date: Aug. 20, 2026

(54) AUTOMATIC DETECTION AND REMOVAL OF BRACES IN THREE-DIMENSIONAL SCANS

(71) Applicant: Align Technology, Inc., San Jose, CA (US)

(72) Inventors: Mikhail TOPORKOV, Darmstadt (DE); Alena LIKHONOSOVA, Moscow (RU); Viacheslav POPOV, Darmstadt (DE); Vitaly TRUFANOV, Moscow (RU); Ivan CHERNOV, Irkutsk (RU); Mariya CHERENKOVA, Moscow (RU); Anton SELEDETS, Schyolkovo (RU); Viacheslav MATSVEI, Novosibirsk (RU); Ivan POTAPENKO, Novosibirsk (RU); Elena KULIKOVA, Madrid (ES); Ekaterina SERGEEVA, Novi Sad (RS)

(21) Appl. No.: 19/464,581

(22) Filed: Jan. 29, 2026

Related U.S. Application Data
(60) Provisional application No. 63/751,270, filed on Jan. 29, 2025.

(51) Int. Cl. G06T 19/00; A61C 7/00; G06T 17/20

(52) U.S. Cl. CPC G06T 19/00; A61C 7/002; G06T 17/20; G06T 2210/36; G06T 2210/41

(57) ABSTRACT

Identifying and removing objects that appear on a three-dimensional (3D) dental scan can include procedures that use one or more neural networks. Some neural networks are trained to identify objects such as braces, orthodontic brackets, wires and the like on surfaces of a tooth. After the objects have been identified, the objects may be removed from the 3D dental scan. Other neural networks are trained to predict the shape of tooth surfaces that are beneath the identified objects. Updated 3D dental scans are generated with the objects removed and replaced with the predicted tooth surfaces.

### CLAIM OF PRIORITY

This patent application claims priority to U.S. Provisional Patent Application No. 63/751,270, titled “AUTOMATIC DETECTION AND REMOVAL OF BRACES IN THREE-DIMENSIONAL SCANS,” filed on Jan. 29, 2025, and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The systems and methods described herein relate generally to three-dimensional dental scans, and more particularly to the detection and removal of braces and other objects from three-dimensional dental scans.

### BACKGROUND

Orthodontic procedures typically involve repositioning a patient’s teeth to a desired arrangement in order to correct malocclusions and/or improve aesthetics. To achieve these objectives, orthodontic appliances such as braces, shell aligners, and the like can be applied to the patient’s teeth by an orthodontic practitioner and/or by the patients themselves. The appliance can be configured to exert force on one or more teeth in order to effect desired tooth movements according to a treatment plan.

Orthodontic aligners may include devices that are removable and/or replaceable over the teeth. Orthodontic aligners may be provided as part of an orthodontic treatment plan. In some orthodontic treatment plans involving removable and/or replaceable aligners, a patient may be provided plurality of orthodontic aligners over the course of treatment to make incremental position adjustments to the patient’s teeth.

The development of an orthodontic treatment plan may include obtaining or receiving a three-dimensional (3D) dental scan of a patient’s dentition. For example, the 3D scan may be used as a starting point for developing the patient’s orthodontic treatment plan. Typically, the 3D scan is obtained prior to any orthodontic treatment. However, in some cases, the 3D scan may be performed on a patient wearing orthodontic braces.

Often, the braces or other attachments are removed from the 3D scan manually by skilled technicians. However, this is a time consuming step and may introduce errors into the altered 3D scan. Furthermore, removing the braces can leave large holes in the 3D scan. The skilled technician is called upon to synthesize or create portions of the 3D scan that were hidden by the braces. Different technicians may create vastly different synthesized tooth areas that can adversely affect the digital model, and in in some cases an orthodontic treatment plan based on the model. These error may also result in poor fit, leading to patient complaints and require subsequent revision.

What is needed is a procedure to remove braces from 3D scans or dental models that does not rely solely on the skill of the technician, and can produce repeatable and accurate results.

### SUMMARY OF THE DISCLOSURE

Described herein are apparatuses, systems, and methods for processing a patient’s 3D dental scans. In some examples, a 3D dental scan can be processed to determine whether any objects are on surfaces of any teeth in the 3D dental scan. The objects can be any feasible object included, but not limited to orthodontic brackets, wires, dental attachments, or the like (e.g., the remnants of braces). After the objects are located and/or determined, the objects can be removed from the 3D dental scan and an updated or revised 3D dental scan generated.

In some examples, the 3D dental scan may be processed by one or more neural networks. In general the networks are trained, for example, a first neural network may be trained to detect objects that are on surfaces of one or more teeth. The 3D dental scan may be represented as a sparse voxel representation. The first neural network may be trained to identify voxels that are associated with the detected objects. In some examples, after the first network the method or system may obtain voxels related remnants of braces (e.g., brackets) and then the faces on the corresponding mesh that correspond to these regions may be identified and those faces cut from the scan. Removing the faces from the scan does not require voxels in a voxel representation. In some examples, the second network may convert a scan surface (e.g., with cuts/holes) to a new voxel representation. Ultimately, this may lead to cut voxels but the second voxel representation may be different from first (for example, the voxel size or actual spatial coordinates may be different).

The identified faces can be removed, resulting in a modification of the sparse voxel representation. A second neural network may be trained to predict tooth surfaces that were previously hidden or occluded by the detected objects. The second neural network can predict voxels that correspond to the hidden or occluded tooth surfaces.

In any of the methods described herein, braces can be removed from a three-dimensional (3D) dental scan by receiving, in a computing device, a 3D dental scan, identifying at least one object disposed on at least one tooth of the 3D dental scan, removing, from the 3D dental scan, faces associated with the at least one object, determining one or more replacement voxels (and/or faces) to replace the removed faces, and generating a revised 3D dental scan based at least in part on the one or more voxels and/or faces to replace the removed faces. In some examples it may be beneficial for the method to determine one or more replacement voxels to replace the removed faces, and generating a revised 3D dental scan based at least in part on the one or more voxels to replace the removed faces, as this may be faster and/or may be more accurate.

In any of the methods described herein, the at least one object includes at least one of an orthodontic bracket, an orthodontic wire, or a combination thereof. In some examples, the at least one object includes any feasible object disposed on a surface of a tooth.

In any of the methods described herein, identifying the at least one object can include converting the 3D dental scan into a first sparse voxel representation comprising voxels having features mapped from the 3D dental scan and convolving the first sparse voxel representation using a first convolutional neural network to identify the at least one object. In some examples, the first convolutional neural network segments the first sparse voxel representation into at least individual teeth and gingiva. In some cases, the first convolutional neural network can determine tooth numbers of teeth in the 3D dental scan. In some further examples, adjusting (in some cases removing, modifying, etc.) the faces associated with the at least one object comprises removing faces associated with the at least one object from the first sparse voxel representation can create a second sparse voxel representation. The one or more replacement voxels and/or faces to replace the removed voxels can include convolving the second sparse voxel representation using a second convolutional neural network to determine the replacement voxels and/or faces.

In any of the methods described herein, determining the one or more voxels (or in some cases faces) to adjust and/or replace the removed faces can include predicting, with a convolutional neural network, voxels to replace the removed voxels.

In any of the methods described herein, generating the revised 3D dental scan can include determining an output 3D mesh having twice a resolution of the replacement voxels. In some examples, the output 3D mesh can be based on a bicubic interpolation of a 3D mesh associated with the replacement voxels. For example, in some cases the neural network(s) may redact some voxels with a determined voxel size; the voxel representation may then be converted to another voxel representation with the twice smaller voxel size, and in some cases may then convert smaller voxels to mesh, and then apply a Laplacian smoothing to the mesh. In some other examples, the method can further include smoothing the output 3D mesh based at least in part on Laplacian smoothing.

In any of the methods described herein, generating the revised 3D dental scan can include filling gaps between the one or more replacement voxels thereby forming a closed surface. However, in general, these methods and apparatuses may not need to fill gaps, as the one or more neural networks may not generate gaps (since there is no gap in the ground truth data used for training).

Any of the apparatuses disclosed herein can include a processor and a memory that includes instructions, which when executed, cause the processor to execute the following steps: receive, in a computing device, a 3D dental scan, identify at least one object disposed on at least one tooth of the 3D dental scan, remove, from the 3D dental scan, faces associated with the at least one object, determine one or more replacement voxels to replace the removed faces, and generate a revised 3D dental scan based at least in part on the one or more voxels to replace the removed faces.

Any of the methods described herein may be performed by a non-transitory computer-readable storage medium comprising instructions to perform the method. For example, a non-transitory computer-readable storage medium may comprise instructions that, when executed by one or more processors of a system, cause the system to perform operations comprising receiving, in a computing device, a 3D dental scan, identifying at least one object disposed on at least one tooth of the 3D dental scan, removing, from the 3D dental scan, faces associated with the at least one object, determining one or more replacement voxels (and/or faces) to replace the removed faces, and generating a revised 3D dental scan based at least in part on the one or more voxels (and/or faces) to replace the removed faces.

Any of the methods described herein can include detecting an uploaded file comprising a 3D dental scan of a patient, detecting an order creation event to determine a orthodontic treatment plan, downloading the 3D dental scan, in response to detecting the uploaded file comprising the 3D dental scan and detecting the order creation event, detecting, from the 3D dental scan, one or more objects disposed on a surface of one or more teeth, and generating an updated 3D dental scan of the patient based on the one or more objects disposed on the surface of one or more objects. The updated 3D dental scan is modified as described herein to remove the faces corresponding to the detected features (e.g., braces).

In some examples, determining the updated 3D dental scan can further comprise removing the one or more objects from the surface of one or more teeth in the 3D dental scan. In some other examples, determining the updated 3D dental scan can further comprise predicting a surface of teeth beneath the one or more objects.

In any of the methods described herein, the objects can include at least one of an orthodontic bracket, an orthodontic wire, or a combination thereof.

In any of the methods described herein can include displaying, on a user interface, a user prompt to remove the one or more objects from the 3D dental scan, detecting a user interaction with the user prompt, and removing faces associated with the one or more objects from the 3D dental scan in response to the user interaction with the user prompt. In some examples, the methods can further include predicting one or more voxels to replace the faces removed that are associated with the detected objects.

Any of the methods described herein can include receiving a user input indicating that the updated 3D dental scan is not suitable for treatment planning and reverting to the downloaded 3D dental scan for treatment planning.

Any of the apparatuses described herein can include a processor, and a memory that includes instructions, which when executed, cause the processor to execute the following steps: detect an uploaded file comprising a 3D dental scan of a patient, detect an order creation event to determine a orthodontic treatment plan, download the 3D dental scan, in response to detecting the uploaded file comprising the 3D dental scan and detecting the order creation event, detect, from the 3D dental scan, one or more objects disposed on a surface of one or more teeth, and determine an updated 3D dental scan of the patient based on the one or more objects disposed on the surface of one or more objects.

A non-transitory computer-readable storage medium comprising instructions that, when executed by one or more processors of a system, cause the system to perform operations comprising: detecting an uploaded file comprising a 3D dental scan of a patient, detecting an order creation event to determine a orthodontic treatment plan, downloading the 3D dental scan, in response to detecting the uploaded file comprising the 3D dental scan and detecting the order creation event, detecting, from the 3D dental scan, one or more objects disposed on a surface of one or more teeth, and determining an updated 3D dental scan of the patient based on the one or more objects disposed on the surface of one or more objects.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a diagram illustrating one variation of a dental computing environment.

FIG. 2 is a block diagram of one example of a braces detection and removal modules.

FIG. 3 is a flowchart of an example method for detecting and removing braces from 3D images.

FIG. 4 is a flowchart of an example method for detecting and removing braces and reconstructing 3D dental images.

FIGS. 5A-5C are images illustrating the braces detection and removal process described herein.

FIG. 6 shows a diagram that depict pixel reconstruction.

FIG. 7 shows a sequence of images illustrating the method of FIG. 4.

FIG. 8 is a simplified diagram of an example system for detecting and removing braces from dental scans.

FIG. 9 shows an example warning that may be displayed to the user.

FIG. 10 shows an example 3D dental image that can be displayed to the user where the braces have been automatically removed.

FIG. 11 shows an example user interface.

FIG. 12 shows an image of a 3D dental scan with braces and an image of a 3D dental scan with the braces removed.

FIG. 13 is a flowchart showing an example method for determining messages on a user interface.

FIG. 14 is a flowchart showing an example method of detecting and removing braces from a 3D dental scan.

### DETAILED DESCRIPTION

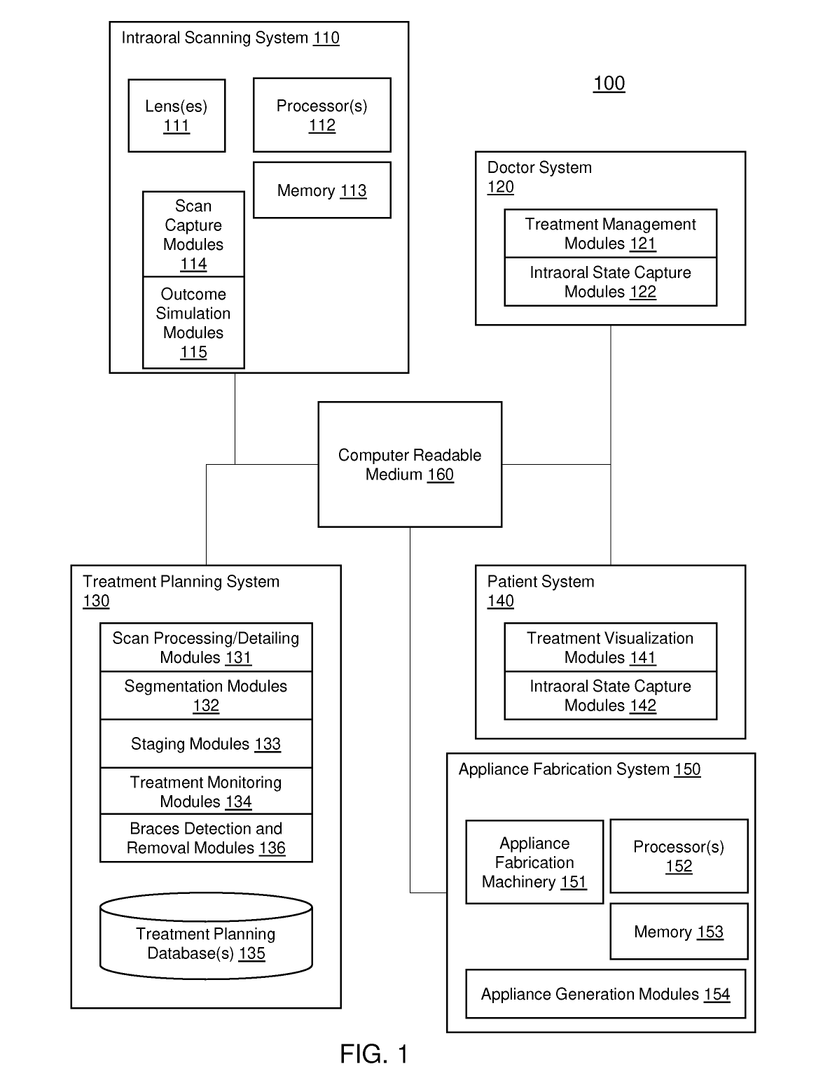

In general, these methods and apparatuses may be used at one or more parts of a dental computing environment, including as part of an intraoral scanning system, doctor system, treatment planning system, patient system, and/or fabrication system. In particular, these methods and apparatuses may be used as part of a treatment planning system, for example, to determine an accurate (in some cases initial) location of a patient’s teeth. The initial location may be used to determine a final location for one or more of the patient’s teeth based on a treatment plan. The treatment plan may be optimized (modified) based on updated dental scans. For example, FIG. 1 is a diagram illustrating one variation of a dental computing environment 100 that may generate one or more orthodontic treatment plans specific to a patient, and fabricate dental appliances that may accomplish the treatment plan to treat a patient, under the direction of a dental professional. The example dental computing environment 100 shown in FIG. 1 includes an intraoral scanning system 110, a doctor system 120, a treatment planning system 130, a patient system 140, an appliance fabrication system 150, and computer-readable medium 160. In some variations the dental computing environment (sometimes referred to as a dental computing system) 100 may include just one or a subset of these systems (which may also be referred to as sub-systems of the overall system 100). Further, one or more of these systems may be combined or integrated with one or more of the other systems (sub-systems), such as, e.g., the treatment planning system 130 and the doctor system 120 may be part of a remote server accessible by a doctor interface. The computer-readable medium 160 may divided between all or some of the systems (subsystems); for example, the treatment planning system 130 and the appliance fabrication system 150 may be part of the same sub-system and may be on a computer-readable medium 160. Further, each of these systems may be further divided into sub-systems or components that may be physically distributed (e.g., between local and remote processors, etc.) or may be integrated.

An intraoral scanning system may include an intraoral scanner as well as one or more processors for processing images. For example, the intraoral scanning system 110 can include lens(es) 111, processor(s) 112, a memory 113, scan capture modules 114, and outcome simulation modules 115. In general, the intraoral scanning system 110 can capture one or more images of a patient’s dentition. Use of the intraoral scanning system 110 may be in a clinical setting (doctor’s office or the like) or in a patient-selected setting (the patient’s home, for example). In some cases, operations of the intraoral scanning system 110 may be performed by an intraoral scanner, dental camera, cell phone or any other feasible device.

The lens(es) 111 include one or more lenses and optical sensors to capture reflected light, particularly from a patient’s dentition. The scan capture modules 114 can include instructions (such as non-transitory computer-readable instructions) that may be stored in the memory 113 and executed by the processor(s) 112 to control the capture of any number of images of the patient’s dentition.

As mentioned, in some examples the methods and apparatuses described herein for generating a 3D model including one or more teeth may be part of, or accessible by, the intraoral scanning system 110, computer-readable medium 160 and/or treatment planning system 130.

For example, the outcome simulation modules 115, which may be part of the intraoral scanning system 110, can include instructions that simulate final tooth positions based on a treatment plan. In some cases, the outcome simulation modules 115 can include instructions that simulate tooth positions using images or other scan data from a dental scan

Any of the component systems or sub-systems of the dental computing environment 100 may access or use the patient’s dental information including scan data, three-dimensional (3D) dental models, and/or treatment plans generated by the methods and apparatuses described herein. For example, the doctor system 120 may include treatment management modules 121 and intraoral state capture modules 122 that may access or use patient scan data and/or 3D dental models. The doctor system 120 may provide a “doctor facing” interface to the computing environment 100. The treatment management modules 121 can perform any operations that enable a doctor or other clinician to manage the treatment of any patient. In some examples, the treatment management modules 121 may provide a visualization and/or simulation of the patient’s dentition with respect to a treatment plan. For example, the doctor system 120 may include a user interface for the doctor that allows the doctor to manipulate and view a patients 3D dental model.

The intraoral state capture modules 122 can provide images of the patient’s dentition to a clinician through the doctor system 120. The images may be captured through the intraoral scanning system 110 and may also include images of a simulation of tooth movement based on a treatment plan.

In some examples, the treatment management modules 121 can enable the doctor to modify or revise a treatment plan. The doctor system 120 may include one or more processors configured to execute any feasible non-transitory computer-readable instructions to perform any feasible operations described herein.

Alternatively or additionally, the treatment planning system 130 may include any of the methods and apparatuses described herein, and/or may determine a mapping between dental scans of a patient that are displaced in time. The treatment planning system 130 may include scan processing/detailing modules 131, segmentation modules 132, staging modules 133, treatment monitoring modules 134, treatment planning database(s) 135, and braces detection and removal modules 136. In general, the treatment planning system 130 can determine a treatment plan for any feasible patient. The scan processing/detailing modules 131 can receive or obtain dental scans (such as scans from the intraoral scanning system 110) and can process the scans to “clean” them by removing scan errors and, in some cases, enhancing details of the scanned image.

The treatment planning system 130 may include a segmentation system that segments a model into separate components. For example, the treatment planning system 130 may include a segmentation modules 132 that can segment a dental model (such as a 3D dental model) into separate parts including separate teeth, gums, jaw bones, and the like. In some cases, the dental models may be based on scan data from the scan processing/detailing modules 131.

The staging modules 133 may determine different stages of a treatment plan. Each stage may correspond to a different dental aligner. In some examples, the staging modules 133 may also determine the final position (also referred to as target position) of the patient’s teeth, in accordance with a treatment plan. Thus, the staging modules 133 can determine some or all of a patient’s orthodontic treatment plan. In some examples, the staging modules 133 can simulate movement of a patient’s teeth in accordance with the different stages of the patient’s treatment plan.

The treatment monitoring modules 134 can monitor the progress of an orthodontic treatment plan. In some examples, the treatment monitoring modules 134 can provide an analysis of progress of treatment plans to a clinician. The orthodontic treatment plans may be stored in the treatment planning database(s) 135. Although not shown here, the treatment planning system 130 can include one or more processors configured to execute any feasible non-transitory computer-readable instructions to perform any feasible operations described herein.

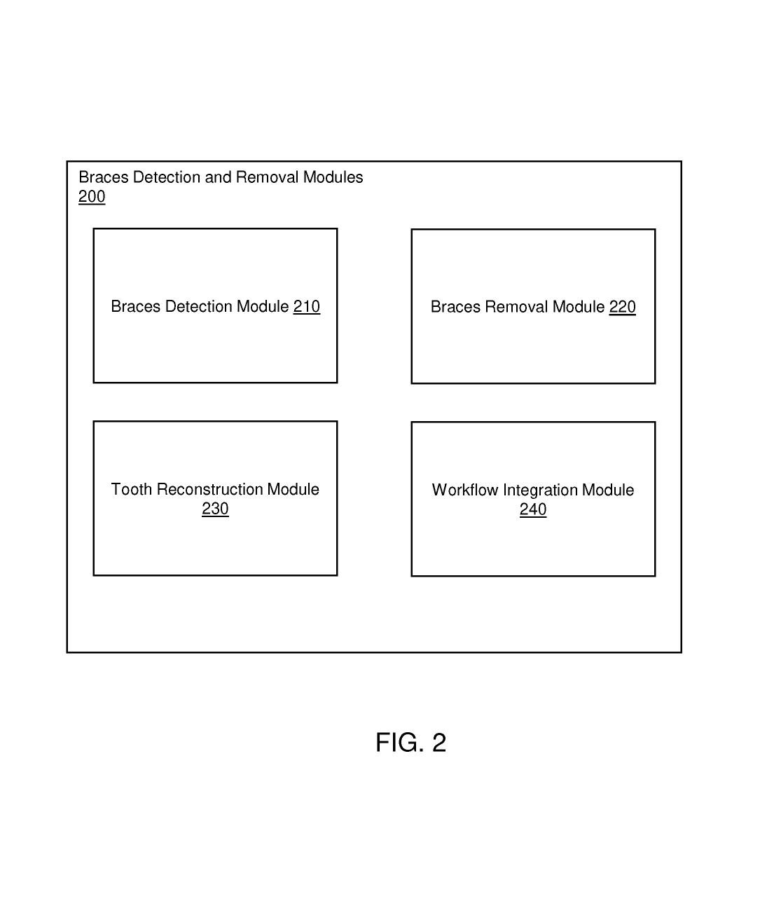

In some examples, the treatment monitoring modules 134 may further include modules that can determine the relationship between a patient’s teeth that are included in two separate dental scans. For example, the treatment monitoring modules 134 can determine a geometric relationship between teeth that are associated with a first dental scan and teeth that are associated with a second dental scan, where the first and second dental scans are separated by time. In some cases the time may be one month, several months, several years, or the like. Further details of the treatment monitoring modules 134 are described herein with respect to FIG. 2. Notably, the functionality of determining a relationship between teeth included in separate dental scans is not limited to the treatment planning system 130, but can be included within any other portion of the dental computing environment 100.

The braces detection and removal modules 136 can detect the presence of objects that are attached to surfaces of one or more teeth in a 3D dental scan. In some examples, the braces detection and removal modules 136 can detect orthodontic brackets, orthodontic wires, attachments, or the like that are affixed to any surface of any tooth. In some cases, the braces detection and removal modules 136 can automatically detect and remove objects (including objects related to braces) from 3D dental scans and also predict tooth surfaces that were hidden by the objects.

In some examples, the braces detection and removal modules 136 may generally be implemented with machine learning-based methods, procedures, approaches, or the like. For example, the braces detection and removal modules 136 may include one or more neural networks trained to recognize braces, wires, brackets, or any other feasible objects disposed or affixed to teeth, or more specifically, any feasible objects that appear attached to teeth on 3D scans or 3D mesh representations of teeth. In some implementations, the braces detection and removal modules 136 can include one or more neural networks trained to predict tooth surfaces, particularly when parts of the tooth surfaces are missing. In some cases, the missing tooth surfaces may be due to the removal of detected or recognized objects that are affixed to teeth.

As described above, machine learning methods and the like may include the execution of trained neural networks. A neural network may be trained to recognize and otherwise detect particular features or subjects within an image. The training of the neural network may include the processing of a training data set. The training data set can include labels that identify the features or subjects of interest. The training data set can also include images without the features or subjects of interest. Training a neural network with such data sets may be referred to as supervised learning.

Some other machine learning methods may be self-trained using un-labeled training data sets. This type of training is sometimes referred to as self-supervised learning. During self-supervised learning, un-labeled data is processed and self-labeled to mimic the way that humans learn. Deep learning can be supervised, unsupervised and semi-supervised (or other types).

Neural networks (or artificial neural networks, ANNs) are said to include a collection of nodes: input nodes, hidden nodes, and output nodes. The nodes may be arranged as layers so that a neural network can include any feasible number of hidden node layers. Each node is coupled to other nodes through edges. For example, a node may generate a signal through an edge to other connected nodes. The signal may be output by the node and be a linear or non-linear function of inputs to the node. Each output signal may be a weighted combination of inputs to the node. If a neural network includes two or more hidden layers, the neural network is sometimes referred to as a deep neural network.

In some neural networks, the hidden nodes may perform convolution. These are referred to as convolutional neural networks (CNN). For example, a convolution kernel can “slide” across an input matrix to generate output signals. In some cases, the convolution can be a dot product (or inner product) of the convolution kernel and a layer’s input matrix. CNNs can advantageously have fewer interconnecting edges between layers (limited by the complexity of the convolution kernel). Fewer interconnecting edges can imply simplified computation compared to ANNs. Other example CNNs can include, but are not limited to, U-Net, ResNeXt, Xception, RefineNet, Kd-Net, SO Net, Point Net, and Point CNN.

Some neural networks can be generative adversarial networks. A generative adversarial network (GAN) can refer to neural networks that may be trained through unsupervised (self-supervised) training. In some examples, two neural networks can compete or contest each other in a form of a zero-sum game. The neural networks can include a generator and a discriminator. The generator creates training data and the discriminator tries to determine whether the created data is real (compared to a ground truth). Through iteration, the GAN can self-train the associated neural network.

Although shown within the treatment planning system 130, the braces detection and removal modules 136 can be implemented or executed with respect to any other feasible system. For example, some or all of the braces detection and removal modules 136 may be implemented or performed with respect to the doctor system 120 and in some cases within the treatment management modules 121. For example, the braces may be removed from a 3D dental model within the treatment planning system 130. The resulting 3D model may be viewed within the doctor system 120 to receive doctor approval. Processing flow may then return to the treatment planning system 130.

The patient system 140 can include treatment visualization modules 141 and intraoral state capture modules 142. In general, the patient system 140 can provide a “patient facing” interface to the computing environment 100. The treatment visualization modules 141 can enable the patient to visualize how a orthodontic treatment plan has progressed and also visualize a predicted outcome (e.g., a final position of teeth).

In some examples, the patient system 140 can capture dentition scans for the treatment visualization modules 141 through the intraoral state capture modules 142. The intraoral state capture modules 142 can enable a patient to capture his or her own dentition through the intraoral scanning system 110. Although not shown here, the patient system 140 can include one or more processors configured to execute any feasible non-transitory computer-readable instructions to perform any feasible operations described herein.

The appliance fabrication system 150 can include appliance fabrication machinery 151, processor(s) 152, memory 153, and appliance generation modules 154. In general, the appliance fabrication system 150 can directly or indirectly fabricate aligners to implement an dental treatment plan. In some examples, the dental treatment plan may be stored in the treatment planning database(s) 135.

The appliance fabrication machinery 151 may include any feasible implement or apparatus that can fabricate any suitable dental aligner. The appliance generation modules 154 may include any non-transitory computer-readable instructions that, when executed by the processor(s) 152, can generate one or more design files that can correspond to stages determined by the staging modules 133. In turn, the one or more design files may be used to build or fabricate one or more dental aligners. In some examples, the appliance fabrication machinery 151 can use the design files to produce the one or more dental aligners. The memory 153 may store data or instructions for use by the processor(s) 152. In some examples, the memory 153 may temporarily store a treatment plan, dental models, or intraoral scans.

The computer-readable medium 160 (sometimes referred to as a non-transitory computer-readable storage medium) may include some or all of the elements described herein with respect to the dental computing environment 100. The computer-readable medium 160 may include non-transitory computer-readable instructions that, when executed by a processor, can provide the functionality of any device, machine, or module described herein.

FIG. 2 is a block diagram of one example of a braces detection and removal modules 200. The braces detection and removal modules 200 may be an example of the braces detection and removal modules 136 of FIG. 1. The braces detection and removal modules 200 may include a braces detection module 210, a braces removal module 220, a tooth reconstruction module 230, and a workflow integration module 240. In general, the braces detection and removal modules 200 detect one or more objects affixed to a surface of one or more of the patient’s teeth within a 3D dental image or scan. The braces detection and removal modules 200 can remove the detected objects from the 3D dental image or scan and then predict the appearance of the tooth surface (previously hidden by the object)..

The braces detection module 210 can receive or obtain a patient’s 3D dental scan or dental image. In some examples, the braces detection module 210 can detect, identify, and otherwise locate braces or other objects located on the patient’s teeth (on the patient’s 3D dental scan and/or the patient’s 3D dental image). In some cases, the braces detection module 210 can also identify a tooth (via tooth number) that included the detected object. The braces detection module 210 can include one or more neural networks trained to detect, identify, and/or locate objects on the patient’s teeth and identify the associated tooth.

In some examples, the braces detection module 210 can generate a 3D sparse voxel representation of the patient’s teeth based on the patient’s 3D dental scan. The 3D sparse voxel representation may be based on a 3D mesh that is mapped to the 3D dental scan or 3D dental image. Each voxel receive or be assigned features that are associated or derived from the 3D dental scan or 3D dental image such as normal vectors with respect to a mesh face, a sum of normal vectors, a count of faces mapped to the voxel, a sum of voxel area, an average of angles, or the like.

The sparse voxel representation may be processed to identify the presence of one or more objects on the patient’s teeth. The identified objects can include braces, orthodontic brackets, wires, dental attachments or any other feasible object. In some examples, the braces detection module 210 can include one or more neural networks that may be used to identify the presence of the one or more objects. In some examples, the neural networks can be trained (either a supervised training or a self-supervised training) to identify or detect the presence of an object within a sparse voxel representation of a patient’s teeth. In some cases, the neural network can also be trained to segment the sparse voxel representation and determine a tooth number associated with the detected object. In some examples, the output can be a binary ‘1’ to indicate the presence of an object and a ‘0’ to indicate that lack of the object.

In some implementations, operations of the braces detection module 210 can be performed with multiple executions of the neural network. For example, a first operation of the neural network can identify the presence of an object on a patient’s tooth and, in some cases, an associated tooth number. A second operation of the neural network can also identify faces in the sparse voxel representation that are associated with the image of the object. The two operation approach may be advantageous particularly when braces detection operations may occur in two or more modules. Advantageously, the same neural network may be used for both the first and second operations described above.

Sparse voxel operations may be described in more detail in U.S. patent application Ser. No. 17/138,824, filed Dec. 30, 2020, now U.S. Pat. No. 11,903,793 which is commonly assigned, and the disclosure of which is incorporated by reference herein in its entirety.

The braces removal module 220 can remove faces associated with the detected object (detected in braces detection module 210) from a sparse voxel representation of a patient’s teeth. In this manner, any faces that have been identified as associated with an object (that is not a tooth, in most cases) can be removed from the sparse voxel representation. Note that removal of these faces can generally result in voids and/or missing surfaces in the sparse voxel representation.

The tooth reconstruction module 230 can fill the voids and/or correct the missing surfaces in the sparse voxel representation that have resulted from the removal of faces, particularly faces associated with detected objects. In some examples, the tooth reconstruction module 230 can include a neural network that has been trained to predict a surface of a tooth, based on a portion of the tooth outer surface. In some cases, the neural network may be trained with teeth that have never had braces.

In some cases, the neural network can generate a “patch” that can replace, at least in part, the missing surface of the tooth. The tooth reconstruction module 230 may also smooth transitions between a patch and the existing tooth surface.

In some examples, the tooth reconstruction module 230 can predict tooth surfaces prior to when the objects (braces and the like) have been removed from the sparse voxel representation.

The tooth reconstruction module 230 can determine voxels for the sparse voxel representation of the patient’s teeth without braces by, in some examples, determining an output 3D mesh with twice the resolution (points) as the input (initial) 3D mesh with the initial sparse voxel representation. The use of twice the resolution in the voxel representation may be used to convert voxels to mesh and twice with respect to the neural network output voxel resolution.

In some cases, the output 3D mesh can be based on a bicubic interpolation of the input 3D mesh. In some other cases, the output 3D mesh can be smoothed based at least in part on Laplacian smoothing.

The workflow integration module 240 integrates the operations of the braces detection module 210, the braces removal module 220, and the tooth reconstruction module 230 into workflows used to prepare orthodontic treatment plans and determine and/or fabricate dental aligners. The workflow integration module 240 can display one or more user interfaces to control the removal of objects from a 3D dental model as well as displaying the patient's 3D dental model both with and without braces. In some implementations, the user can have the braces detection module 210, the braces removal module 220, and the tooth reconstruction module 230 automatically (without user intervention) remove braces from the 3D dental model.

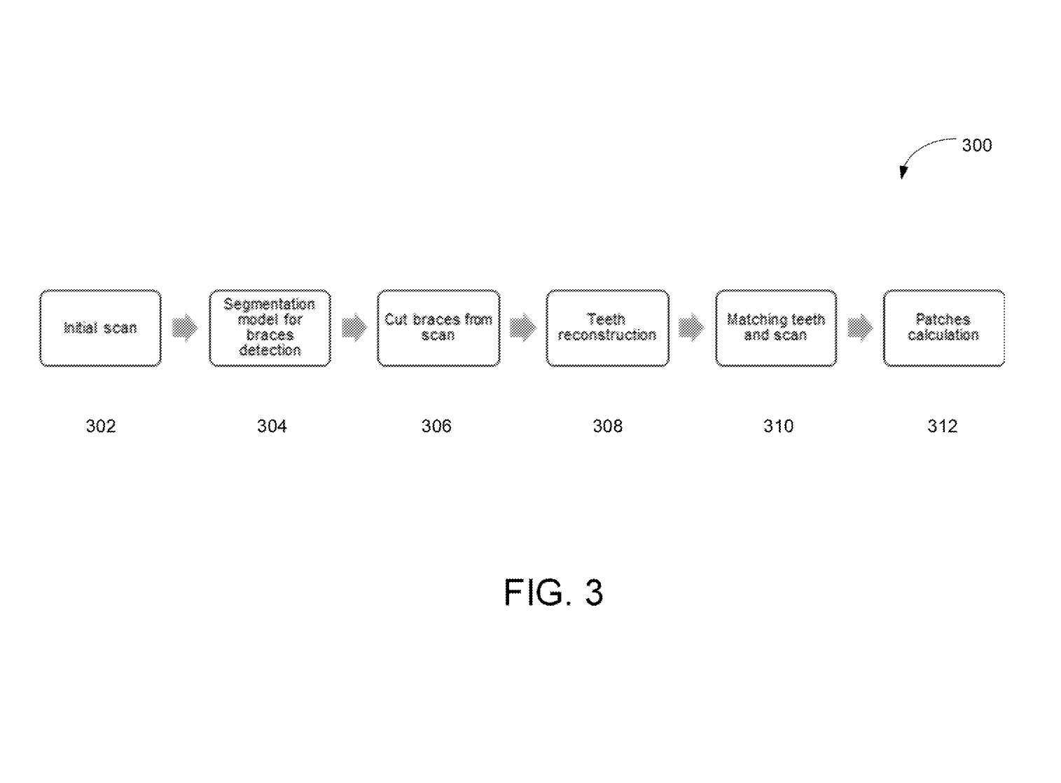

FIG. 3 is a flowchart of an example method 300 for detecting and removing braces from 3D images. The example method 300 is described with respect to the dental computing environment 100 of FIG. 1 and/or the braces detection and removal modules 200 of FIG. 2, but may be performed with any feasible apparatus, system, environment, or the like.

The method begins in block 302 when a scan of the patient’s dentition is performed. In some examples, the intraoral scanning system 110 can capture a 3D dental scan (intraoral scan) of the patient. The 3D dental scan can include both upper and lower dental arches and include any objects, such as orthodontic brackets, wires, and the like that are attached to the patient’s teeth. In some examples, the 3D dental scan is processed to generate a 3D dental model.

Next, in block 304 the 3D dental model is segmented for braces detection. For example, the braces detection module 210 can operate on the 3D dental model to determine whether braces, wires, or any other feasible object is attached to the patient’s teeth. A sparse voxel representation can be generated from the 3D dental model. One or more neural networks may be used to determine a location of any objects on the surface of the patient’s teeth as well as determine which faces are part of the object and which faces are part of the patient’s teeth.

Next, in block 306 braces are cut from the scan. For example, the braces removal module 220 can cut braces from a scan. In some examples, after braces are detected in block 304, the faces associated with the braces (or other objects detected in block 304) may be removed from a sparse voxel representation of the patient’s 3D dental model. In some cases, removal of the faces associated with the braces may leave voids on surfaces of the sparse voxel representation.

Next, in block 308 tooth reconstruction occurs, in block 310, matching teeth and scan occurs and in block 312 patches calculation occurs. Viewed together as a group, these blocks replace the faces that have been removed in previous blocks. For example, the tooth reconstruction module 230 can determine voxels to replace the faces that were removed in block 306. In some examples, replacement faces/voxels may be determined with one or more neural networks. The replacement voxels/faces may form patches that can replace some or most of the tooth face that was removed.

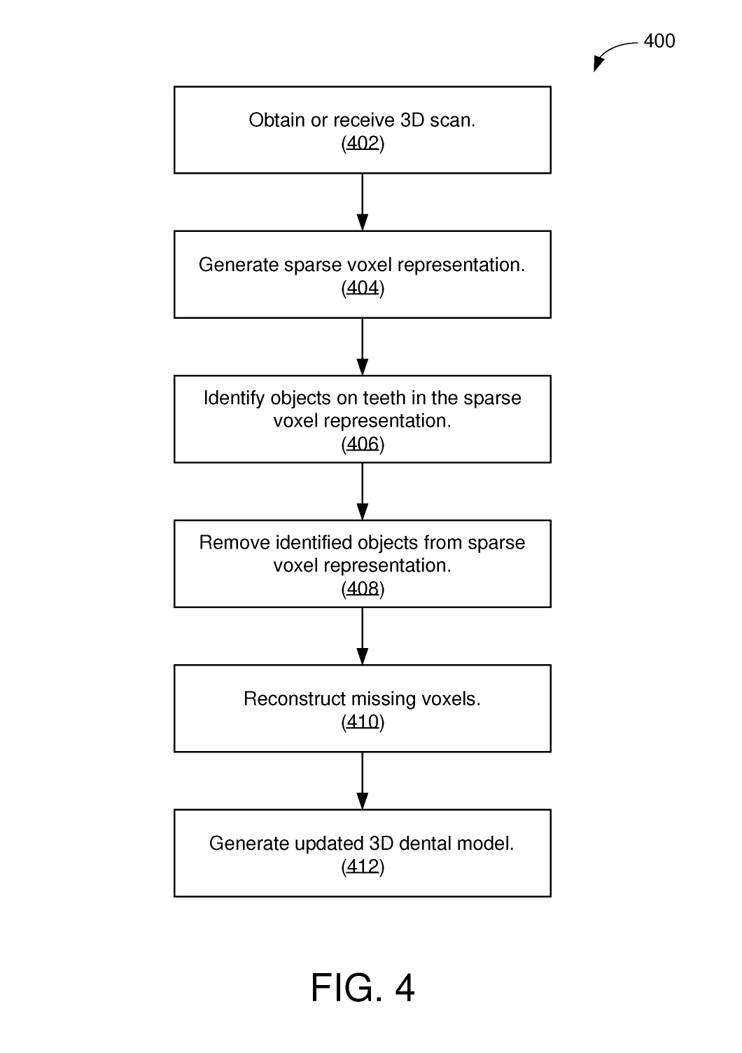

FIG. 4 is a flowchart of an example method 400 for detecting and removing braces and reconstructing 3D dental images. The method 400 begins in block 402 as a 3D dental scan is obtained or received. The 3D dental scan may be from an intraoral scanner or any other feasible device. Next, in block 404 a sparse voxel representation of the 3D dental scan is generated. For example, the 3D dental scan is converted into a sparse voxel representation of the 3D dental scan. That is, data from the 3D dental scan is used to generate the sparse voxel representation. Each voxel can include features associated with, or derived from, the 3D dental scan. The sparse voxel representation may include voxels distributed on a 3D mesh.

Next, in block 406, objects on teeth of the sparse voxel representation are identified. For example, a neural network may be used to identify any feasible object that is located or disposed on a tooth surface. In some examples the objects may be identified using a convolutional neural network. That is, the sparse voxel representation may be convolved with a kernel of the convolutional neural network to identify feasible objects. Feasible objects may include, but are not limited to, braces, orthodontic brackets, wires, dental attachments, or the like. In some cases, the neural network can also segment the sparse voxel representation into teeth (individual teeth) and gingiva. The neural network can also identify individual teeth, in some cases by assigning the teeth a tooth number.

Next, in block 408 the identified objects are removed from the sparse voxel representation. For example, some or all of the faces associated with an identified object (identified in block 406) can be removed from the sparse voxel representation creating an updated (or second) sparse voxel representation. Note, removing faces from the sparse voxel representation can create voids or empty spaces in the updated sparse voxel representation due to the missing regions.

Next, in block 410 missing regions are reconstructed. For example, a neural network (different than the neural network used in block 406) can process the updated sparse voxel representation to reconstruct the missing faces. In other words, a neural network may be used to determine the shape and contour of the missing faces of a tooth’s surface (the tooth shape) with respect to the updated sparse voxel representation. The neural network may sometimes be referred to as a completion network. In some examples, the neural network can be a convolutional neural network. That is, the sparse voxel representation may be convolved with a kernel of this convolutional neural network to reconstruct or generate the replacement voxels.

In some examples, the neural network can generate substantially all of the missing faces. The replacement faces are sometimes referred to as a patch or patches. In some cases the replacement faces, or the patch, may not completely replace all the missing/removed faces. In those cases the missing faces can be determined or synthesized so that all the replacement faces can form a closed surface with respect to the updated sparse voxel representation. The patches may be generated from the mesh surface.

Next, in block 412 an updated 3D dental model is generated. In some examples, the updated 3D dental model is generated from the updated sparse voxel representation that includes the replacement voxels and/or faces. In some implementations, an output 3D mesh may be defined or generated based on the 3D mesh associated with the updated sparse voxel representation. In some cases, the output 3D mesh may have an increased resolution (for example twice the resolution) of the sparse voxel representation. As an example, bicubic interpolation can be used to determine the output 3D mesh. In some other examples, the output 3D mesh or the voxels of the updated 3D dental model can be smoothed with Laplacian smoothing. After any processing of the updated sparse voxel representation, the updated sparse voxel representation is converted into an updated 3D dental model.

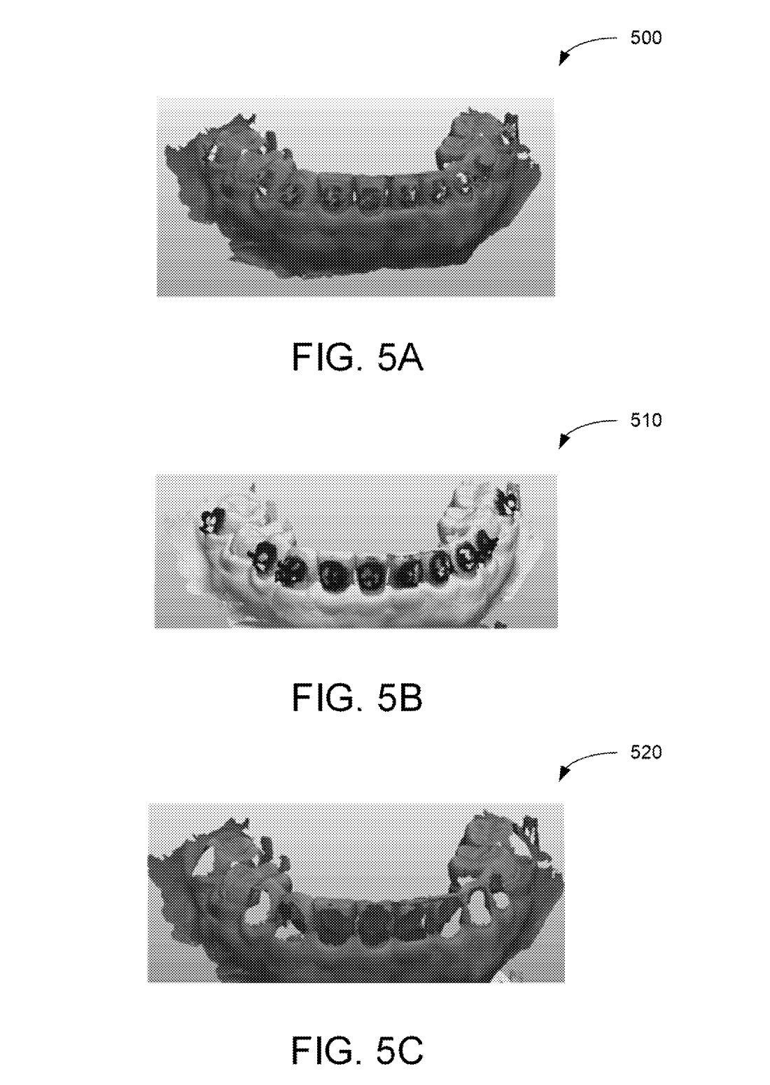

FIGS. 5A-5C are images illustrating the braces detection and removal process described herein. FIG. 5A shows a first 3D dental scan 500 of a patient’s dentition. Note that the first 3D dental scan 500 includes objects (in this case, braces or orthodontic brackets) that are affixed to surfaces of some of the patient’s teeth.

FIG. 5B shows an image 510 where the faces (in some examples pixels and/or voxels) associated with the detected object are marked. In this case, the brackets and immediate tooth area next to the brackets may be marked. FIG. 5C shows an image 520 of the patient’s dentition after the marked pixels/voxels/faces are removed. Note, the removal of these faces can result in voids (missing portions) in the 3D dental image.

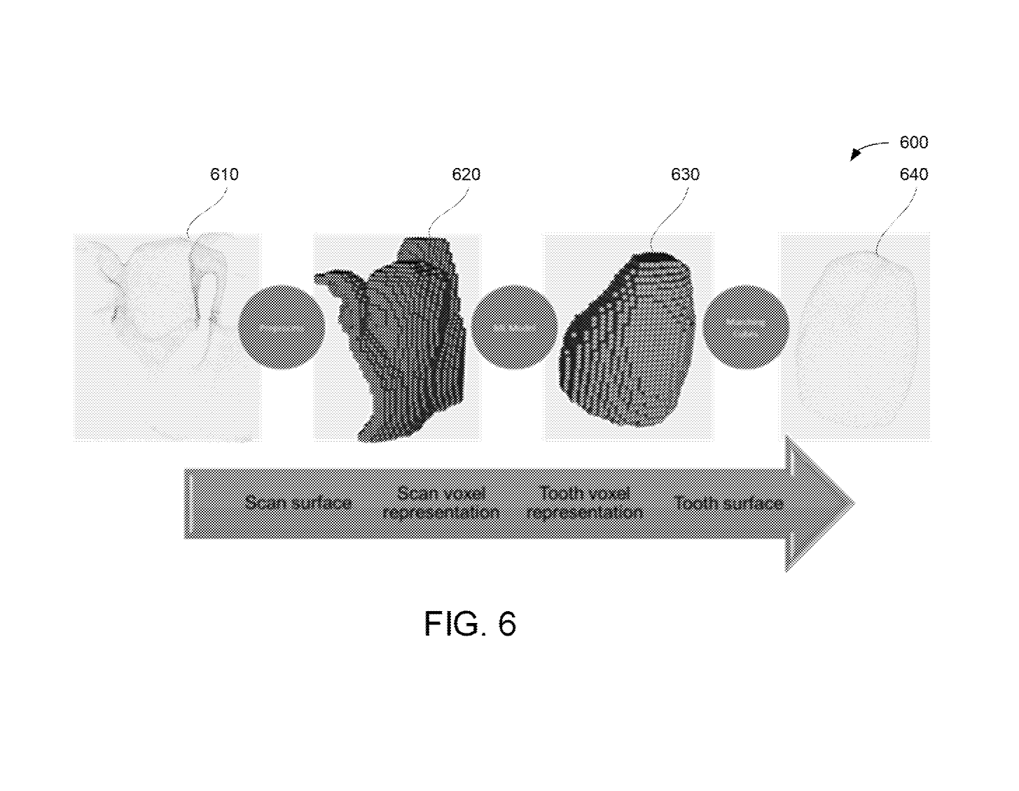

FIG. 6 shows a diagram 600 that depicts pixel reconstruction. The pixel reconstruction may proceed as described with respect to tooth reconstruction module 230 of FIG. 2 and block 410 of FIG. 4. Image 610 shows an image of a portion of an initial 3D dental scan. Image 620 shows a sparse voxel representation of the 3D dental scan of image 610. In some cases, although not shown here, the sparse voxel representation in image 620 may include, or have removed, objects such as braces, wires, or the like. Next, image 630 shows a transformation from the sparse voxel representation of image 620 to an updated sparse voxel representation where any missing faces have been replaced. In some examples, the missing faces may be determined with one or more neural networks. Next, image 640 shows a point cloud representing a restored 3D dental scan or dental image.

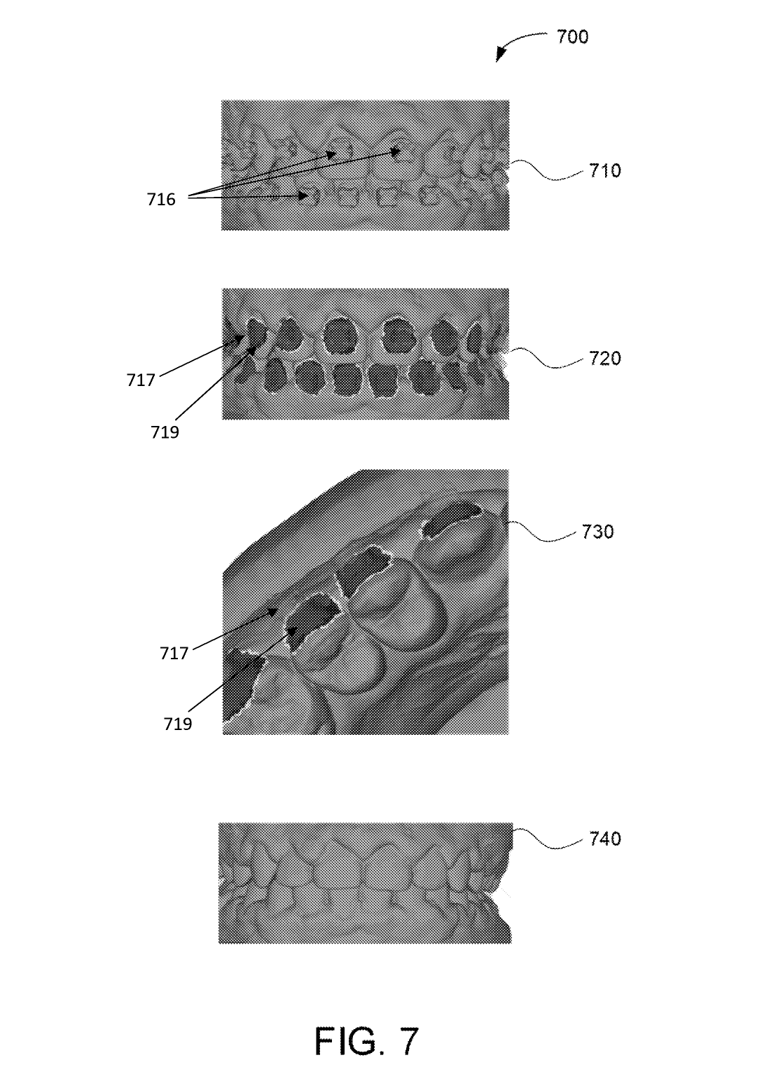

FIG. 7 shows a sequence of images 700 illustrating the method of FIG. 4. Image 710 is a 3D dental scan of a patient’s dentition. As shown, the 3D dental scan includes braces 716 on at least some of the teeth. Image 720 shows areas (ligher regions 717) on the 3D dental scan that correspond to identified objects, such as braces, and darker regions 719 corresponding to patches. Image 730 shows patches within the 3D dental scan, where the patches have replaced the identified objects. Image 740 shows a 3D dental scan, where the area adjacent to the patches have been filled and smoothed. Thus, image 740 shows a 3d dental scan with objects (braces) removed and the tooth surfaces, previously occluded by the braces clearly shown.

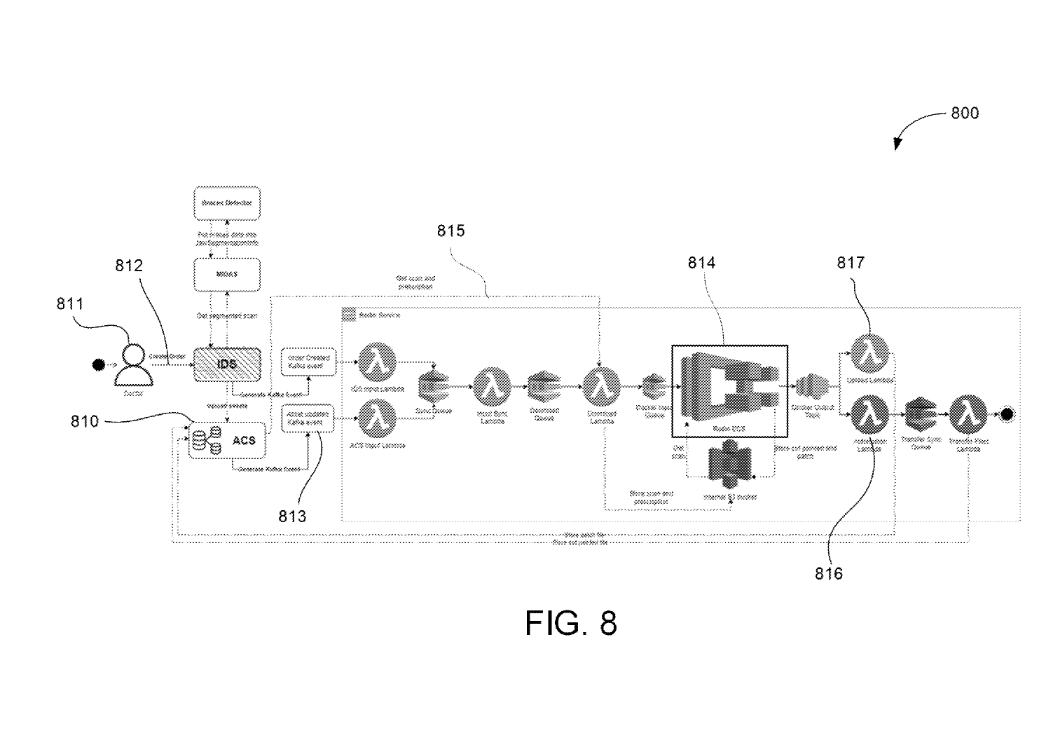

FIG. 8 is a simplified diagram of an example system 800 for detecting and removing braces from dental scans. Elements of the system 800 may be associated with the workflow integration module 240 of FIG. 2. In some other examples, the system 800 may be incorporated with parts of the treatment planning system 130 and/or the doctor system 120 of FIG. 1. A patient’s 3D dental scans and prescription may be stored in a datastore 810. A prescription may describe a desired final position of the patient’s teeth. In some examples, the datastore 810 may be a remotely accessible datastore, server, or the like. A doctor 811 can submit an order 812 to the system 800. The order 812 can be an order creation event that requests that an orthodontic treatment plan be created. Optionally in some examples, anorthodontic treatment plan may determine a series of stages and corresponding aligner to more teeth from an initial position to a final position. The initial position may be determined, at least in part, by the patient’s 3D dental scan.

The system detects the order 812 and the patient data corresponding to the order 812 in the datastore 810. In response to detecting the order 812 and the corresponding data, the system 800 architecture can download (obtain) 813 patient data and treatment plan from the datastore 810 into the system 800. The download data is conveyed or transmitted to a processing core 814.

The processing core 814 represents a region within the system 800 where the braces detection and removal can occur. For example, patient data 815 (including patient 3D dental scans) can be retrieved from the datastore 810 and routed to the processing core 814. Within the processing core 814, braces (or other objects) may be detected and removed from the 3D dental scans. Furthermore, the 3D image can be reconstructed so that portions of the tooth that were previously hidden or occluded by braces, now appear as surfaces of the teeth. In some examples, any machine learning, neural network-based processing is performed in the processing core 814.

In some examples, the processing core 814 can output a processed file (image) of the patient’s teeth without braces. In this manner, braces can automatically be removed from a patient’s 3D dental image. This processed file may be stored in datastore 816. In some implementations, automatic removal of braces may be used when predicted collisions between teeth shapes do not exceed 0.05 mm. That is, using the processed file without braces and applying a orthodontic treatment plan, the resulting positions of teeth do not have collisions that exceed 0.05 mm. Furthermore, the processing core 814 should not detect any issues with the predicted teeth shapes (but may detect other issues).

In addition, the processing core 814 can output and store the patches data. That is, the processing core 814 can output the reconstructed voxels and associated 3D dental image data. This data may be presented later to a user. This data may be uploaded to a datastore 817.

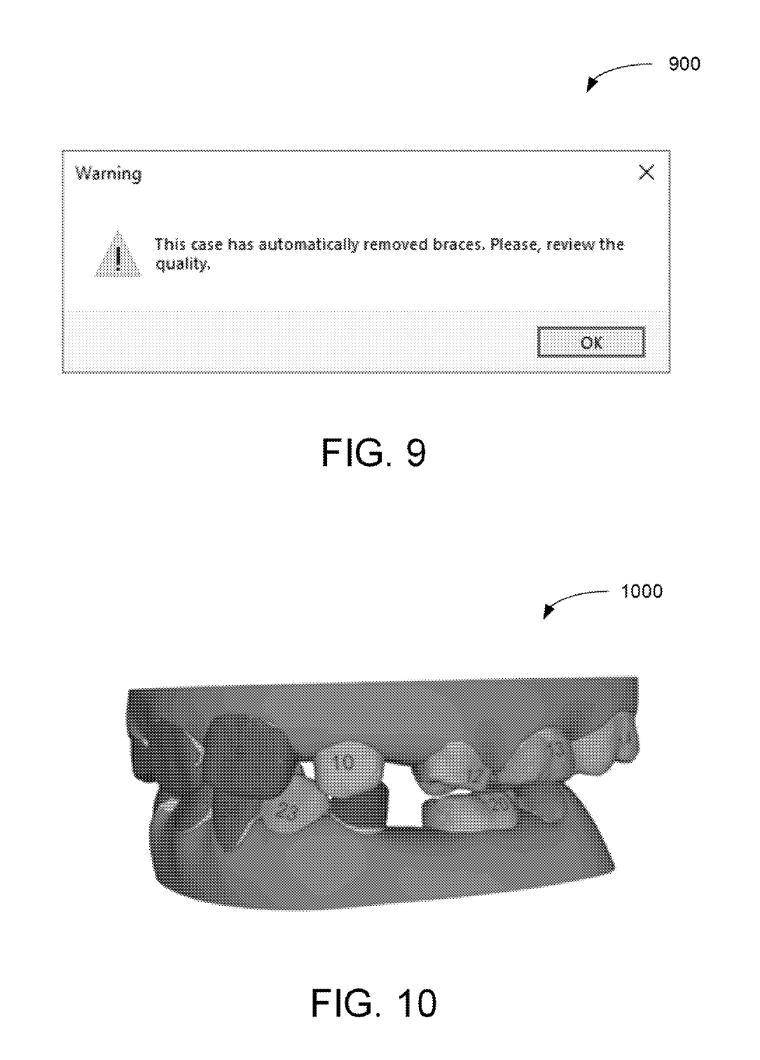

Two possible workflows are possible with the system 800. In a first workflow, a user (sometimes referred to as a CAD designer) can use the processed file with the braces already removed. In some cases, the user is presented a warning to indicate that the braces have been removed from the image. FIG. 9 shows an example warning 900 that may be displayed to the user. FIG. 10 shows an example 3D dental image 1000 that can be displayed to the user where the braces have been automatically removed. The user can review the image 1000 and determine if the image is suitable for use in treatment planning. The user can discard the changes and revert to an earlier (originally downloaded) 3D dental image if the user determines that the 3D dental image is not suitable for treatment planning.

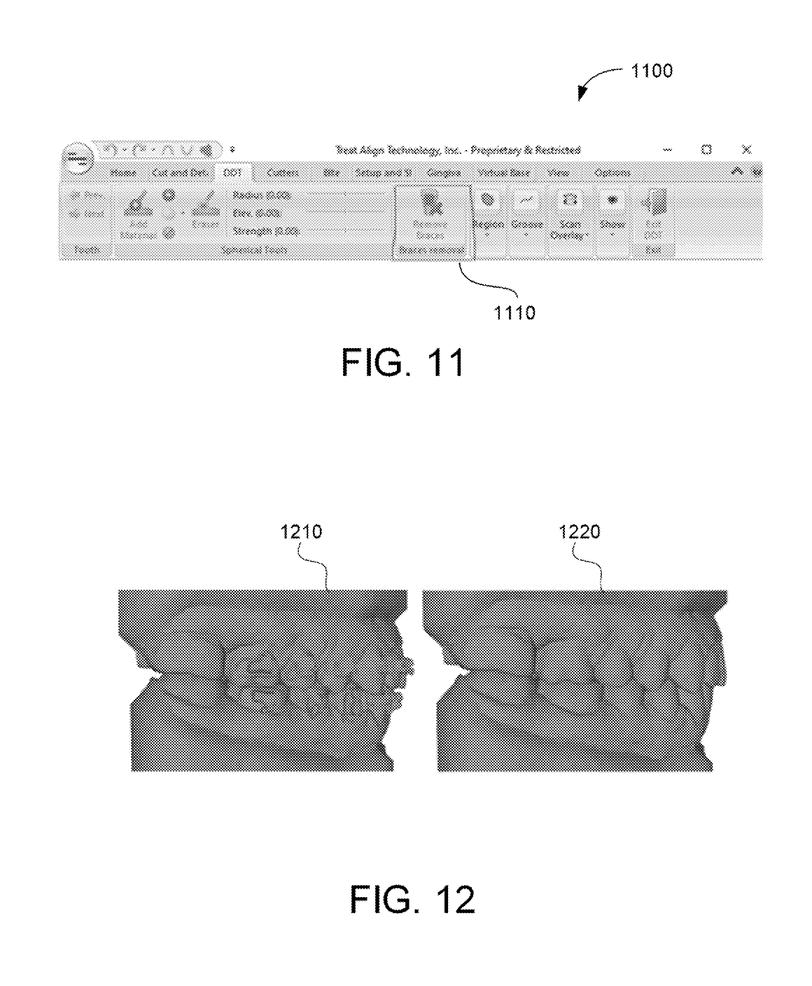

In a second workflow, the user may review the 3D dental images and select, through a user interface, whether the braces should be removed from an image using the methods described herein. For example, a user can interact with the user interface to indicate that the user would like to generate a 3D dental image without detected objects (braces, wires, and the like). FIG. 11 shows an example user interface 1100 with an action region 1110 that can receive an indication from the user that braces should be removed from the 3D dental scan.

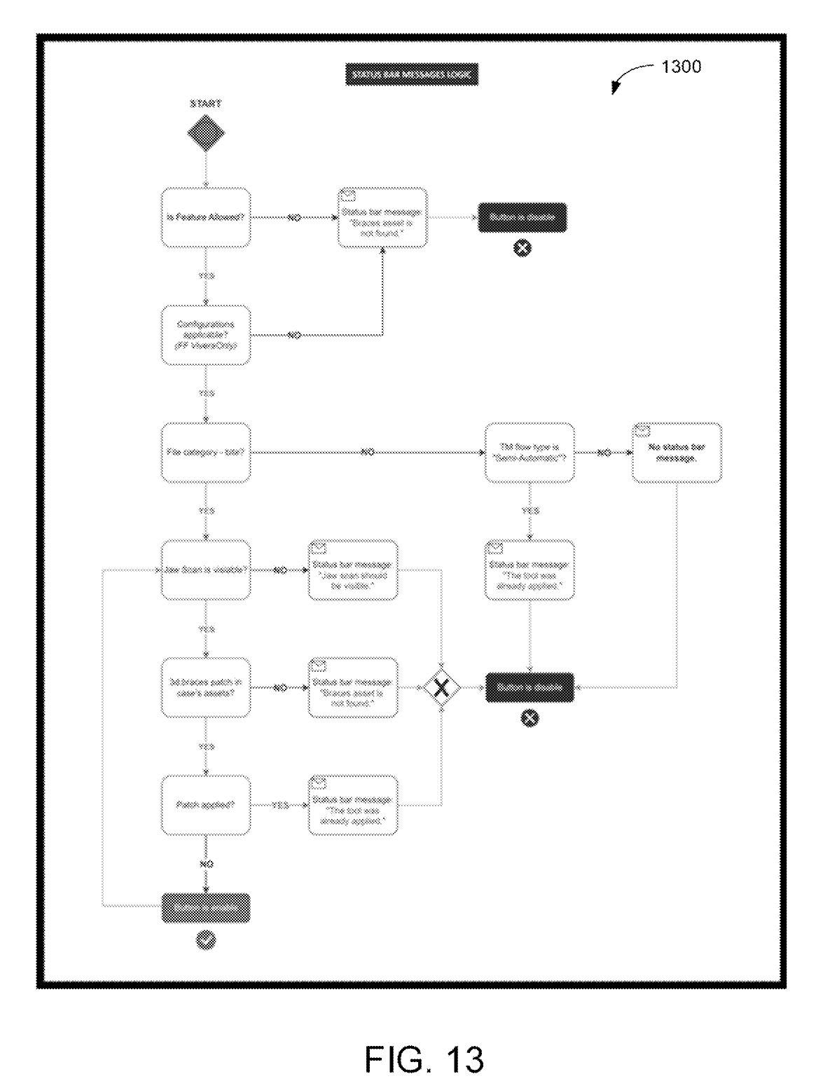

FIG. 12 shows an image 1210 of a 3D dental scan with braces and an image 1220 of a 3D dental scan with the braces removed, for example through the user interface 1100. FIG. 13 is a flowchart showing an example method 1300 for determining messages on a user interface. The user interface can be the user interface 1100 of FIG. 11. Messages can include status messages regarding braces, 3D dental scan, tool status, and the like. The method 1300 is merely one example method for determining outcomes of a user interface. Other methods are possible. In some examples, the method 1300 can determine when a user interface displays any particular user controls.

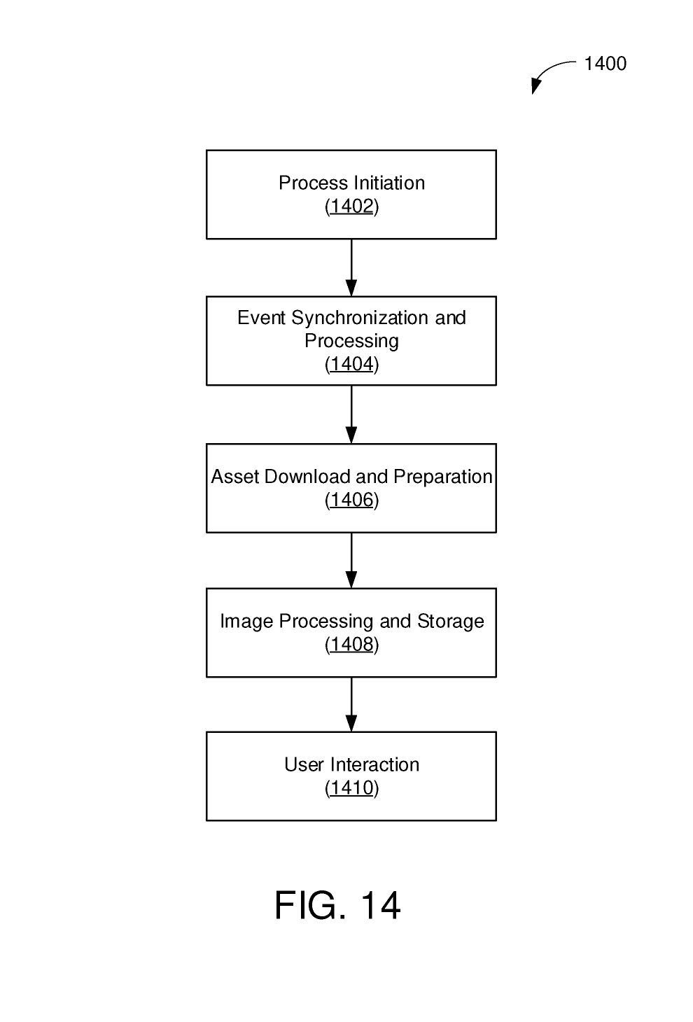

FIG. 14 is a flowchart showing an example method 1400 of detecting and removing braces from a 3D dental scan. The method can begin in block 1402 with a process initiation. In this block, files needed for detecting and removing braces are uploaded to servers or datastores. In some examples, an uploaded file can include a 3D dental scan of a patient. The 3D dental scan may include braces, wires and the like on teeth of the patient. Another uploaded file can include an order or instruction to determine an orthodontic treatment plan. The order or instruction is generally provided by a doctor or clinician, and in some cases can trigger the method of detecting and removing braces from an image. The files can be uploaded to any feasible data center, remote server, remote storage device, or the like.

Next, in block 1404 event synchronization and processing may occur. In some examples, the asset uploads are confirmed and the associated task is submitted to a queue. In some examples, the event synchronization and processing may include determining the presence of a prescription, or desired final position of the patient’s teeth, and/or may check that a scan and prescription are present for a given order.

Next, in block 1406 asset download and preparation is performed. In some examples, the 3D dental scans, prescription, and order (treatment order) may be retrieved from any remote devices. In some examples, any related queues may also be downloaded.

Next, in block 1408 image processing and storage occurs. In some examples, objects (braces, wires, and the like) may be detected on a patient’s 3D dental image, deleted or removed from the 3D dental image, and an updated 3D dental image created based on a prediction of tooth surfaces that are now visible since the objects have been removed. For example, any of the procedures described with respect to FIGS. 2 or 4 may be used to detect and remove objects on 3D images. The updated 3D dental image, as well as any other related files (image files with removed faces, files including voxels/faces of predicted tooth shapes, and the like) may be stored locally or remotely. In this manner any files associated with object removal are made available to any user or other program.

Next, in block 1410 user interaction is detected. In some examples a user interface is displayed. The user interface may include regions, zone, buttons, and the like with which the user can interact with and determine one or more actions. For example, the user interface may include a first region with which the user can interact with to generate a 3D dental image without external objects. In another example, the user interface may include a second region with which the user can interact with and reject any generated 3D dental image as unsuitable for use.

In some examples, methods herein are based on 3D deep learning model for surface prediction and 3D segmentation model for braces detection. The whole pipeline consists of several blocks including synthetic data generation for model training, detection of braces and patch construction. Consisting of: 1) Generation of ROIs (Regions of Interest) on scan with braces based on deep learning segmentation model to detect braces. Then part of the scan where braces were detected is removed. 2) Prediction of teeth shapes from scan surface with cut braces area based on 3D deep learning reconstruction network. 3) Patch creation for surfaces marked as braces. 4) Developed method to create scans with braces artificially to get reliable ground truth dataset.

Some advantages may include 1) Fully automated solution that replace manual braces removal. 2) Has a better quality and works much faster than manual removal. 3) Doesn't require to collect ground truth dataset with braces. 4) As the result we can not only modify scan surface but also create teeth shapes. 5) Can be easily extended to other orthodontic elements, lingual bars, buttons, rings, etc.

Motivation: We propose to patients with braces to use our more advanced product. Usually, doctor perform scanning for patient with braces before braces are removed so then braces must be manually removed from scan surface. This process is both very inaccurate and time consuming for technicians. The processing of the case with braces takes at least twice time compared to regular scan. So, developing of the automatic tool for braces removal is crucial for product expansion.

Overview: The most challenging issue for braces removal automatic tool is the absence of reliable ground truth data. Among the available data we have mostly the scans with manually removed braces. But manually procedure is neither accurate nor defined. Technicians process the same case in a different manner because each tech uses his own imagination to restore scan shape under the braces area. To resolve this issue, we introduce method for automatic generation of artificial scans with braces on cases originally without braces. In this case we know the result.

3D Neural network based on sparse convolutions was trained to find faces on scan that belongs to the braces area. Those faces will be further removed from initial scan. The procedure is very similar to that was described in above mentioned patent. The only difference that as ground truth manually segmented braces area on scan was used.

Tooth reconstruction: 3D Completion network based on sparse convolutions is trained. As Ground truth teeth shapes corresponding to scan are used. For each tooth network sees neighbor area on scan and learn to predict faces and/or voxels representation of resulting tooth shape. In some cases the model learns to predict voxels only around resulting tooth shape and removes unused ones. For each predicted voxel the system may also train to predict SDF signed distance to the tooth surface. This will be used on postprocessing stage to restore mesh from voxels. On postprocessing stage, the system may use twice detailed voxel grid to obtain more detailed 3D mesh. Distances for refined voxel grid are calculated using bicubic interpolation from initial voxels. Then, an algorithm, such as a Marching cubes algorithm, may be is used to restore tooth mesh. Laplacian smoothing may also be applied to the teeth meshes.

Shape modification: On this stage patches are created for scan which will replace parts of the scan were marked as braces. Predicted teeth shapes are matched to the scan and the part of the tooth laying under the bracket is now considered as patch.

Asynchronous process: the system works within the asynchronous process and based on Cloud Infrastructure which ensures that: No other services (such as MES or ACS) are waiting for the result, which keeps the stable pipeline. In case of service or any components are not available − the case processing isn’t being stopped or interrupted. The CAD Designer could process the case manually. The system doesn't overwrite any files, which leads to data safety, nothing is being lost. The system allows to easily return or undo the changes for CAD Designer in case of insufficient quality. The system can be easily scaled and adapted to increased load.

Step 1. Initiation based on Events Generation: This process happens outside of the service but is a prerequisite for cases processing. There are two events generated by outside systems: Order Creation in IDS. When a doctor creates an order using the IDS, a Kafka event is generated, that has the order information. Asset Upload to ACS. Simultaneously, a 3D scan and a prescription is uploaded to the ACS, generating another Kafka event.

Step 2. Events Synchronization and Processing Listen for 2 Kafka events described above. The system initiates when both events for the same order are received as the braces removal process cannot be started before the doctor submitted the case and assets were uploaded to ACS, making it possible to download the scan. ACS Input Lambda. This function processes the asset upload event, ensuring the file is ready for further processing. If a case fits the requirements, a message is sent into the Sync queue. IDS Input Lambda. This function processes the order creation event, preparing the system to handle the new order. Same as with ACS listener, if the case successfully go through all filters, a message is sent into the Sync queue. Sync Lambda. Ensures both events are present for a case. After receiving a message from SQS, the function creates a folder in S3, specifying the received event. When 3 events are collected: prescription upload, scan upload and order created − the message to Download queue is sent.

Step 3. Assets Download and Preparation Download Queue. Files (scan, prescription) are queued for download. Download Lambda. Downloads the necessary files from ACS and prepares them for processing. Docker Input Queue. Places the downloaded files in a queue for processing by Docker ECS.

Step 4. Braces Detection and Removal on 3D-Scan Docker ECS. The core processing unit where braces are detected and removed from the 3D scan. Detection Algorithm. Utilizes advanced machine learning models to identify braces on the scan. Removal Process. Removes braces from the scan, reconstructing the jaw's 3D geometry. Output Generation. Generates the processed file without braces (cut painted file) along with the patch and stores it for further use.

Step 5. Post-Processing and Storage Patches Upload Lambda. Uploads the processed file to ACS, creating a new asset for the patient (patch). Automation Lambda. Assesses the cut painted output and based on that decides whether to use the result for further treatment planning or not. Two criteria used: The collisions between teeth shapes do not exceed 0.05 mm. The ML based detector did not detect any issues with teeth shapes. Transfer Files. Transfers the cut painted files to appropriate storage locations and queues.

Step 6. User (CAD Designer) Interaction The system supports two workflows that complement each other. The “Cut Painted Flow” provides teeth shapes generated by 3D ML Reconstruction with pre-removed braces already. The “Patch Flow” assumes the braces are still on the scan, when CAD Designer receives the case, but the assets containing the patch file to replaces the parts of teeth surface on the initial scan with the new ones to remove the braces. The patches are created for all applicable cases, while the cut painted file has more applicability criteria along with the quality check in Automation Lambda and provided for about 95% of cases.

If a cut painted file was created for the case, when the CAD Designer starts working with the order, they instantly see it in Treat application. A special warning is shown to make sure that the technician will check the quality of teeth shapes. In case the cut painted file was not created or the quality did not satisfy the CAD Designer, he can use an alternative flow, by opening the initial scan with braces and applying a patch. In Treat application, the "Remove braces" button allows DDT technicians to apply the patch to automatically remove braces. When the jaw scan is visible and the patch is present, the button becomes available.

The CAD designers can revert to the original scan if the automated removal does not meet the required standards using the "Undo" button. The "Redo" button allows to return the braces removal result. If the “Remove Braces” button is disable in Treat – a special status bar message will appear, when hovering a mouse over the disabled button, providing the information why the button is disabled.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being "on" another feature or element, it can be directly on the other feature or element or intervening features and/or elements may also be present. In contrast, when a feature or element is referred to as being "directly on" another feature or element, there are no intervening features or elements present. It will also be understood that, when a feature or element is referred to as being "connected", "attached" or "coupled" to another feature or element, it can be directly connected, attached or coupled to the other feature or element or intervening features or elements may be present. In contrast, when a feature or element is referred to as being "directly connected", "directly attached" or "directly coupled" to another feature or element, there are no intervening features or elements present. Although described or shown with respect to one embodiment, the features and elements so described or shown can apply to other embodiments. It will also be appreciated by those of skill in the art that references to a structure or feature that is disposed "adjacent" another feature may have portions that overlap or underlie the adjacent feature.

Terminology used herein is for the purpose of describing particular embodiments only and is not intended to be limiting of the invention. For example, as used herein, the singular forms "a", "an" and "the" are intended to include the plural forms as well, unless the context clearly indicates otherwise. It will be further understood that the terms "comprises" and/or "comprising," when used in this specification, specify the presence of stated features, steps, operations, elements, and/or components, but do not preclude the presence or addition of one or more other features, steps, operations, elements, components, and/or groups thereof. As used herein, the term "and/or" includes any and all combinations of one or more of the associated listed items and may be abbreviated as "/".

Spatially relative terms, such as "under", "below", "lower", "over", "upper" and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as "under" or "beneath" other elements or features would then be oriented "over" the other elements or features. Thus, the exemplary term "under" can encompass both an orientation of over and under. The device may be otherwise oriented (rotated 90 degrees or at other orientations) and the spatially relative descriptors used herein interpreted accordingly. Similarly, the terms "upwardly", "downwardly", "vertical", "horizontal" and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word "about" or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/- 0.1% of the stated value (or range of values), +/- 1% of the stated value (or range of values), +/- 2% of the stated value (or range of values), +/- 5% of the stated value (or range of values), +/- 10% of the stated value (or range of values), etc. Any numerical values given herein should also be understood to include about or approximately that value, unless the context indicates otherwise. For example, if the value "10" is disclosed, then "about 10" is also disclosed. Any numerical range recited herein is intended to include all sub-ranges subsumed therein. It is also understood that when a value is disclosed that "less than or equal to" the value, "greater than or equal to the value" and possible ranges between values are also disclosed, as appropriately understood by the skilled artisan. For example, if the value "X" is disclosed the "less than or equal to X" as well as "greater than or equal to X" (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of detecting and removing braces from a three-dimensional (3D) dental scan, the method comprising:
receiving, in a computing device, a 3D dental scan;
identifying at least one object disposed on at least one tooth of the 3D dental scan;
removing, from the 3D dental scan, faces associated with the at least one object;
determining one or more replacement voxels and/or faces to replace the removed faces; and
generating a revised 3D dental scan based at least in part on the one or more voxels and/or faces to replace the removed faces.

2. The method of claim 1, wherein the at least one object includes at least one of an orthodontic bracket, an orthodontic wire, or a combination thereof.

3. The method of claim 1, wherein identifying the at least one object includes:
converting the 3D dental scan into a first sparse voxel representation comprising voxels having features mapped from the 3D dental scan; and
convolving the first sparse voxel representation using a first convolutional neural network to identify the at least one object.

4. The method of claim 3, wherein the first convolutional neural network segments the first sparse voxel representation into at least individual teeth and gingiva.

5. The method of claim 3, wherein the first convolutional neural network determines tooth numbers of teeth in the 3D dental scan.

6. The method of claim 3, wherein removing the faces associated with the at least one object comprises removing faces associated with the at least one object from the first sparse voxel representation to create a second sparse voxel representation.

7. The method of claim 6, wherein determining the one or more replacement voxels and/or faces to replace the removed faces comprises convolving the second sparse voxel representation using a second convolutional neural network to determine the replacement voxels and/or faces.

8. The method of claim 1, wherein determining the one or more voxels and/or faces to replace the removed faces comprises predicting, with a convolutional neural network, tooth shapes to replace the removed faces.

9. The method of claim 1, wherein generating the revised 3D dental scan comprises determining an output 3D mesh having twice a resolution of the replacement voxels and/or faces.

10. The method of claim 9, wherein the output 3D mesh is based on a bicubic interpolation of a 3D mesh associated with the replacement voxels and/or faces.

11. The method of claim 9, further comprising smoothing the output 3D mesh based at least in part on Laplacian smoothing.

12. The method of claim 1, wherein generating the revised 3D dental scan comprises filling gaps between the one or more replacement voxels and/or faces thereby forming a closed surface.

13. An apparatus comprising:
a processor; and
a memory that includes instructions, which when executed, cause the processor to execute the following steps:
receive, in a computing device, a 3D dental scan;
identify at least one object disposed on at least one tooth of the 3D dental scan;
remove, from the 3D dental scan, faces associated with the at least one object;
determine one or more replacement voxels and/or faces to replace the removed faces; and
generate a revised 3D dental scan based at least in part on the one or more voxels and/or faces to replace the removed faces.

14. A method of detecting and removing braces from a three-dimensional (3D) dental scan, the method comprising:
detecting an uploaded file comprising a 3D dental scan of a patient;
detecting an order creation event to determine a orthodontic treatment plan;
downloading the 3D dental scan, in response to detecting the uploaded file comprising the 3D dental scan and detecting the order creation event;
detecting, from the 3D dental scan, one or more objects disposed on a surface of one or more teeth; and
determining an updated 3D dental scan of the patient based on the one or more objects disposed on the surface of one or more objects.

15. The method of claim 14, wherein determining the updated 3D dental scan further comprises removing the one or more objects from the surface of one or more teeth in the 3D dental scan.

16. The method of claim 14, wherein determining the updated 3D dental scan further comprises predicting a surface of teeth beneath the one or more objects.

17. The method of claim 14, wherein the objects include at least one of an orthodontic bracket, an orthodontic wire, or a combination thereof.

18. The method of claim 14, further comprising:
displaying, on a user interface, a user prompt to remove the one or more objects from the 3D dental scan;
detecting a user interaction with the user prompt; and
removing voxels associated with the one or more objects from the 3D dental scan in response to the user interaction with the user prompt.

19. The method of claim 18, further comprising:
predicting one or more voxels to replace the voxels removed that are associated with the detected objects.

20. The method of claim 14, further comprising:
displaying the updated 3D dental scan.

21. The method of claim 20, further comprising:
receiving a user input indicating that the updated 3D dental scan is not suitable for treatment planning; and
reverting to the downloaded 3D dental scan for treatment planning.
